(19) United States
(12) Patent Application Publication
(10) Pub. No.: US 2009/0016168 A1
(43) Pub. Date: Jan. 15, 2009

(54) Timepiece Device

(76) Inventor: Emily Smith, St. Paul, MN (US)

Correspondence Address: FISH & RICHARDSON P.C., PO BOX 1022, MINNEAPOLIS, MN, 55440-1022, US

(21) Appl. No.: 12/170,704

(22) Filed: Jul. 10, 2008

Related U.S. Application Data
(60) Provisional application No. 60/949,403, filed on Jul. 12, 2007.

(51) Int. Cl. G04B 47/00; G04C 19/00

(52) U.S. Cl. 368/10; 368/82

(57) ABSTRACT

A timepiece apparatus is described that includes a display area that is able to present different colors, a timing mechanism that is able to track the passage of time, a display mechanism that is able to change the color of the display area, wherein the color corresponds to a time period, and an interface for associating the color displayed with the time period, wherein the association is customizable by a user.

### CLAIM OF PRIORITY

This application claims priority to U.S. patent application Ser. No. 60/949,403, filed on Jul. 12, 2007, the entire contents of which are hereby incorporated by reference.

### TECHNICAL FIELD

This invention relates to timepieces and time telling devices.

### BACKGROUND

Children and other individuals may have difficulty telling time using typical clock features such as clock hands or digital displays.

### SUMMARY

The time telling devices described utilize color as a method of showing the current time. One or more colors may be used to correspond to various times of the day or activities. For example two colors may be used to show daytime and nighttime. As another example, multiple colors may be used for separate meal times, nap time, bedtime, etc. In one implementation, a timepiece apparatus is described that includes a display area that is able to present different colors, a timing mechanism that is able to track the passage of time, a display mechanism that is able to change the color of the display area, wherein the color corresponds to a time period, and an interface for associating the color displayed with the time period, wherein the association is customizable by a user.

The interface for associating the color displayed with the time period may utilize elapsed time measurement for changing the color displayed, or may utilize actual clock time measurement for changing the color displayed. The display area may be able to present one or more images, or the display area may include a device for projecting the color displayed against another surface external to the device. The display area may be able to present one or more numbers.

Variously, the timepiece apparatus may include other features. The timepiece apparatus may include a microphone. The timepiece apparatus may include a night light. The timepiece apparatus may include a digital display. The timepiece apparatus may include one or more speakers and a device for playing audio. The device for playing audio may include a media player, such as an mp3 player, CD player, or cassette player.

The device for playing audio may include an interface able to connect to or communicate with an external audio device, such as an mp3 player or other device. The device for playing audio may be connected with the timing mechanism, such that audio may only be played at certain times which correspond with specified color displays. The timepiece apparatus may also include hands or other mark (e.g., arrow, colored bar, blinking dot, etc.) for tracking the passage of time. Typically, the hands or mark may be displayed on the timepiece apparatus, but these may also be physical in some implementations.

The timepiece apparatus may include a reading light, wherein the reading light is connected with the timing mechanism, such that the reading light may only be operated at certain times which correspond with specified color displays. The timepiece apparatus may be built into an object. For example, it may be built into a doll, animal, car, or other toy.

The timepiece apparatus may include a remote control, wherein the remote control may be used to access programming features of the timepiece apparatus. The timepiece apparatus may include a secured access panel for obtaining access to the settings for the device. The timepiece apparatus may include an interface for communicating, such that the device settings may be obtained from an external device or source.

In one implementation, a system for telling or teaching time is described that includes means for measuring the passage of time, means for setting a time period, means for displaying a color, wherein the color displayed corresponds to the time period, and means for associating the displayed color with the time period. The means for displaying a color may include an area for projecting the color displayed on the device.

In one implementation, a container apparatus is described that includes one or more compartments able to hold small objects, a display area that is able to present different colors, a timing mechanism that is able to track the passage of time, a display mechanism that is able to change the color of the display area, wherein the color corresponds to a time period, and an interface for associating the color displayed with the time period, wherein the association is customizable by a user.

The container apparatus may include additional features. The container apparatus may include an audio alert system, may include a visual alert system, and/or may include a remote notification system. The one or more compartments of the container apparatus may form part or all of the display area.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1A shows an exemplary timepiece that represents time using color and images rather than numbers.

FIG. 1B shows an example clock that uses color to indicate the current time.

FIG. 1C shows an example clock that can use resized images in various positions on the clock face.

FIG. 2 shows an example clock that displays the time digitally in addition to using images.

FIG. 3 shows an example configuration of the clock in which it is stacked with other components.

FIG. 4 shows an example back side of the clock.

FIG. 5 shows example controls that can be used for programming the table-top clock.

FIG. 6 shows an example watch configuration for housing the timepiece.

FIG. 7 shows an example globe configuration for housing the timepiece.

FIG. 8 shows an example projector configuration for housing the timepiece.

FIG. 9 shows an example CD player and light configuration for housing the timepiece.

FIG. 10 shows an example timepiece that includes an outer hours region.

FIG. 11 shows an example timepiece that includes an hour hand and a minute hand.

FIG. 12 shows an example of a digital clock implementation of the timepiece.

FIG. 13 shows an example of the timepiece built into an object.

FIG. 14 shows an example orb clock implementation of the timepiece that uses color to indicate the current time.

FIG. 15 shows an example of the timepiece built into a pill box.

FIG. 16 shows an example of the timepiece built into an independent desk light.

FIG. 17 shows an example of the timepiece built into an independent music player.

Like reference symbols in the various drawings indicate like elements.

### DETAILED DESCRIPTION

A toddler may use a timepiece (e.g., a bedside clock, wall clock, projection clock, wristwatch, etc.) to tell time. Such a timepiece may provide time-related information presented at a level that the child can understand. In some implementations, the timepiece may provide simple functionality suitable for a younger toddler. In other implementations, additional components operable with the timepiece may be purchased and integrated over time as the child matures. Such an approach may allow the timepiece to manufactured with minimal production costs. In fact, the timepiece may be manufactured to be optionally integratable through the use of standard-sized ports, jacks and other interfaces. In other implementations, the timepiece may already include more complex functionality. In some implementations, the timepiece may “grow” with the child as additional functionality may be used as the child matures, such as by providing simple information initially, then adding more complex information (e.g., numbers, etc.) as the child gets older and is able to comprehend more detailed information. For example, a timepiece may initially represent time using color only. As the toddler or child ages, the timepiece may include images in a display, so that time is represented using color and images. Later, the timepiece may include numbers in addition to the color and images in a display. In some implementations, the timepiece may discontinue the use of images in order to represent time using just color and numbers. The above may be examples of implementations that describe possible progressions of a timepiece that “grows” with the child, but other progressions are possible.

In some implementations, the timepiece may include features that allow the toddler's parent, guardian or older sibling to control how the timepiece provides time-related information to the toddler. For example, as a child ages, the child's parent may increase the complexity of time-related information that the child sees. The timepieces described below are example implementations of toddler timepieces that may occur, for example, as states or phases of one or more programmable timepieces, such as those that may be programmable by the child's parent. For example, one such phase or state can correspond to a toddler clock that is currently representing time using color only. In some implementations, the timepieces described below can include features that may be controllable by the toddler.

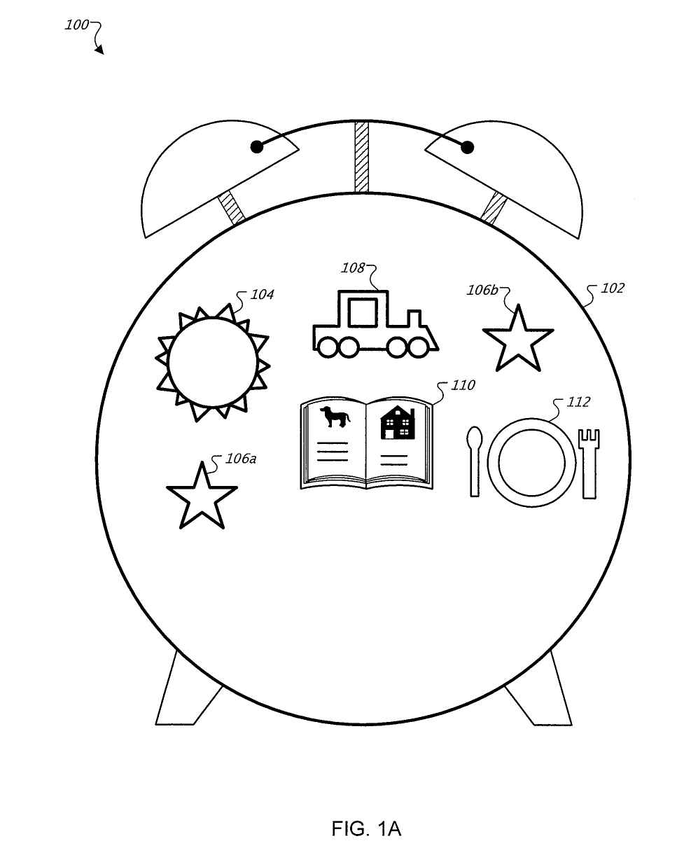

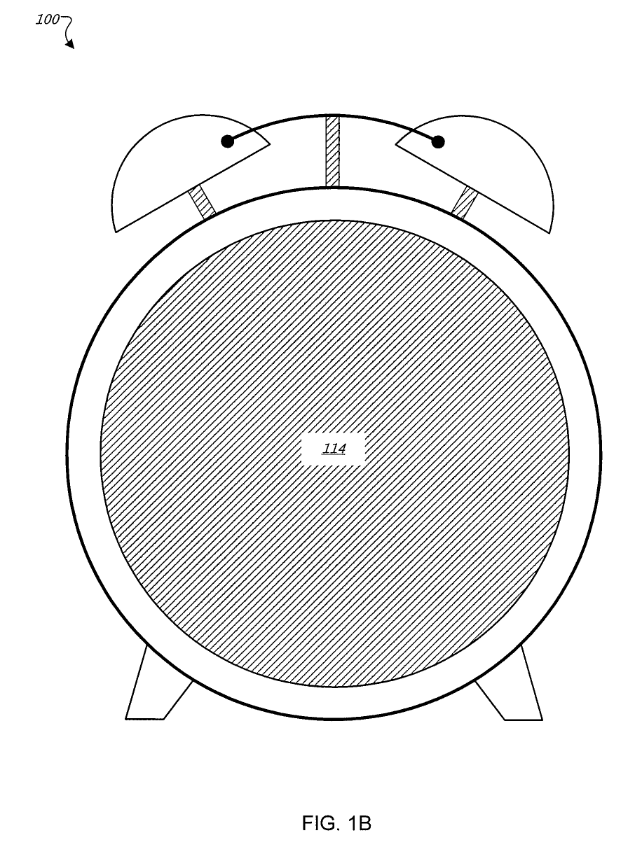

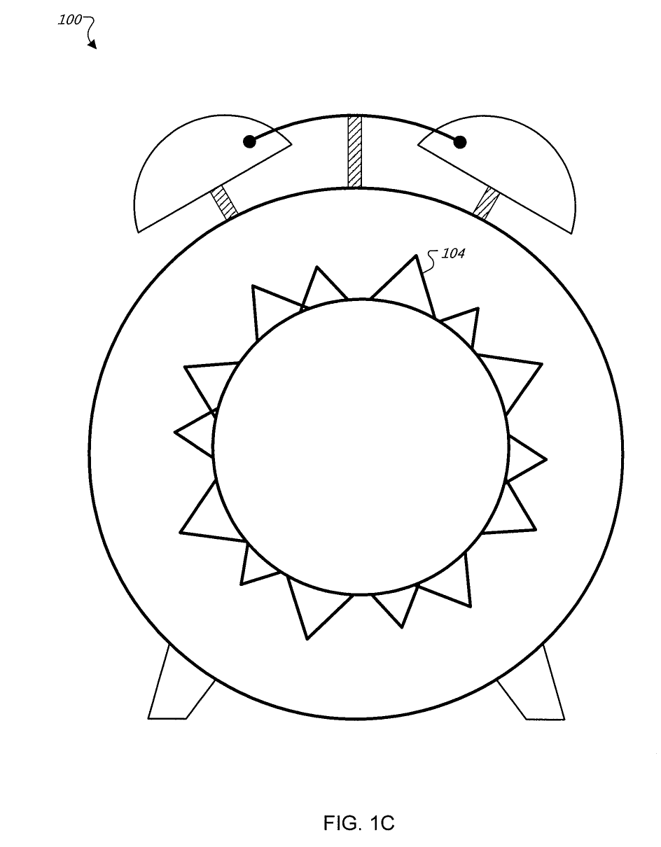

FIG. 1A shows an exemplary timepiece 100 that represents time using color and images rather than numbers. The timepiece 100 can be used, for example, to assist children in determining the difference between waking time and sleeping time. The timepiece 100 can further be used to indicate to the child appropriate times for particular activities, such as quiet play time.

In one implementation, the timepiece (or clock) 100 can be included in the configuration shown in FIG. 1A, which depicts an alarm clock. As shown, the clock 100 includes a round clock face 102, but any shape (e.g., square, rectangle, triangle, octagon, semi-circle, etc.) can be used for the clock's face.

The clock face 102 includes graphical images 104-112. Each of the images 104-112 can represent one or more particular times and/or activities in a child's day. A particular image may be displayed (or otherwise fully visible) only during the time for which the image represents. For example, the sun image 104 may serve to indicate to a child when the time is “waking hours” (e.g., not sleeping hours). Specifically, the sun image 104 may be programmed (e.g., by a parent or guardian) to be displayed at a pre-determined time each morning and to turn off at a certain time (e.g., the child's bedtime). Similarly, the clock 100 may include images for nighttime, such as star images 106a and 106b, which can indicate to a child when the current time is “sleeping” time. In some implementations, when a particular images is not “displayed” (e.g., using bright lights, LEDs, etc.), its faint outline may still be visible. In other implementations, the image may be displayed together with the light and thus not visible when not displayed.

In some implementations, the sun image 104 and the star images 106a and 106b may be co-programmed to operate alternatively. For example, the clock 100 may have a programmable time setting for switching between “waking hours” and “sleeping hours.” Specifically, at the programmed time, the sun image 104 can turn on when the star images 106a and 106b turn off. In some implementations, the clock 100 may allow different times to be set, for example, for non-school nights (e.g., weekends or holidays). In some implementations, the clock 100 may recognize Daylight Saving Time, and may automatically adjust the time (e.g., by an hour in the spring and fall).

Making an image visible (e.g., at pre-determined times) can be facilitated by various controls or mechanisms. In one implementation, one or more light emitting diodes (LEDs) can be positioned behind a particular image. For example, an LED positioned behind the sun image 104 may turn on in the morning to make the sun image 104 fully visible, and may turn off again at night to obscure it. When a particular image is off, the clock 100 may show an outline or shadow of the image so that it is still recognizable by the child. Doing so can serve as a visual reminder to the child who may know that the “time” associated with the image occurs, for example, only when the light is on.

Liquid crystal displays can be used to display images. Such displays can be static images that turn on and off, or the liquid crystal displays can provide animation or other more substantial displays. In another example of making an image visible, images 104-112 may have a mechanical cover or some other obscuring device that is lifted or otherwise removed at prescribed times to display particular images. In some implementations, the clock 100 may have a combination of controls and mechanisms for displaying and hiding images.

The clock 100 may include other images that are recognizable to a child and are symbolic of a child's activities, such as train image 108 and book image 110. Such images 108 and 110 may be displayed, for example, during a child's quiet playtime. In particular, the times at which images 108 and 110 are displayed may be pre-programmed by the child's parent or guardian using controls on the clock 100. In some implementations, various playtime images may exist, each designating a different type of activity in which the child is allowed to undertake. For example, while the book image 110 may indicate to a child that it is time for quiet reading, another image, such as an image of playground equipment, may indicate that the child can play outside and be noisy if desired. In some implementations, other images may indicate the time that a child is to perform certain chores, such as feeding the family pet. In such case, an image may serve as a reminder (e.g., acting as a simple alarm clock). The clock 100 may further include buttons that the child can press to indicate that the chore is complete. Pressing such a button may turn off the display of the chore-related image. In the case in which the child may choose from several activities, multiple images may be displayed, such as a simultaneous display of images corresponding to quiet and other activities from which the child may choose.

In some implementations, gender based images may be selectable for programming into the clock face 102. For example, while the train image 108 may be a suitable image for boys (and some girls) who like trains, a doll or other girl-oriented image may be displayable for girls. In some implementations, programmability of the clock 100 may include a switch or control for specifying, for example, the gender of the child for whom the clock 100 is intended. In certain implementations, the switch may have a neutral setting such that the parent or guardian may select from a complete collection of images.

In some implementations, additional images, such as the mealtime image 112, may indicate the time for a family meal or snack. For example, the mealtime image 112 may be displayed around dinnertime each night. In order to help the child to differentiate dinnertime from breakfast or lunchtime, another image may be displayed simultaneously with the mealtime image 112. For example, the sun image 104 may be used to indicate that the meal is breakfast, or the stars 106a and 106b may be used to indicate that the meal is dinner.

Different colors may be used for different images 104-112. For example, yellow may be used for the sun image 104, and blue may be used for the star images 106a and 106b. Colors may also be used to differentiate between different types of meals, such as yellow for breakfast, red for lunch, and blue for dinner.

In some implementations, a time change represented by the clock may include more than simply turning an image on or off. For example, an audible chime or other sound may accompany an image that is newly displayed, and the image itself may flash or blink for a few seconds. In this way, the child may be alerted to a change in time without having to monitor the clock 100.

When a child gets older and is thought to be ready to tell time using more traditional (e.g., non-image) displays, the parent can program the clock 100 to further display the time in other ways. Programming the clock 100 may be accomplished using programming controls accessible, for example, through the back of the clock 100. One example of a reprogrammed clock 100 will now be described.

FIG. 1B shows an example clock 100 that uses color to indicate the current time. Specifically, images (such as images 104-112 depicted in FIG. 1A) can be omitted completely in such a color-only configuration of the clock 100. In particular, region 114 (shown shaded) may light up with a color that represents the current time. For example, the region 114 may be entirely yellow at day break or at the beginning of “waking” time such as the pre-determined time programmed by the child's parent. Other times, such as sleeping time, may be coded in other colors (e.g., blue). Such colors may be visible during the day and/or made visible in the dark by means of lights, etc.

FIG. 1C shows an example clock 100 that can use resized images in various positions on the clock face. For example, the sun image 104 is depicted as a significantly larger image than that depicted in FIG. 1A. In some implementations, the clock 100 may automatically enlarge a newly-displayed image, such as enlarging the sun image 104 at the beginning of waking time. In other implementations, images can be relocated automatically, such as changing image positions to place some images in more prominent locations on the clock face. In other implementations, the clock 100 may automatically resize a displayed image to fit the clock face.

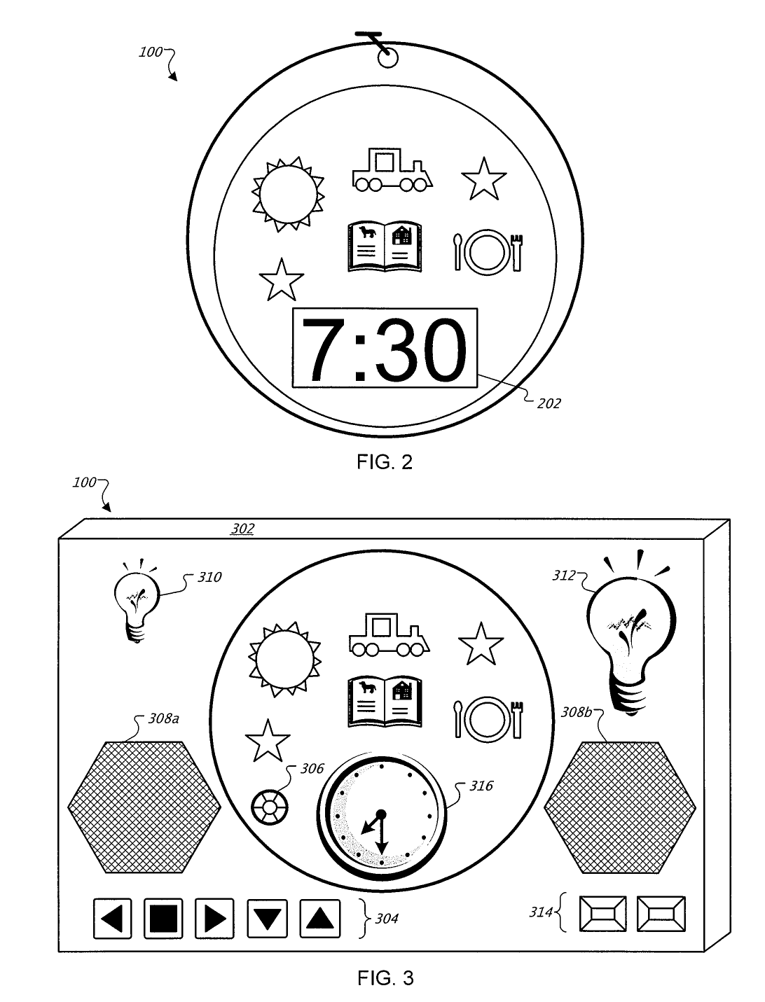

FIG. 2 shows an example timepiece (or clock) 100 that displays the time digitally in addition to using images 104-112. As depicted, the clock 100 is a wall clock, but a digital time display 202 can be present in other implementations of the clock 100. The digital time display 202 may be located in an area of the clock face 102 in which no images 104-112 exist so that each can be viewed simultaneously. In other implementations, the digital time display 202 may replace images that are deemed no longer necessary, such as if the child has outgrown their utility. In some implementations, as images and the times they represent are mastered by the child, the clock 100 may be programmed to no longer display them.

FIG. 3 shows an example configuration of the clock 100 in which it is stacked with other components. In some implementations, the clock face 102 can be mounted in a cabinet 302 that houses other components that can be operated easily by a child. For instance, the components may include a music player or other entertainment system. In some implementations, the music player may be enabled (e.g., able to be turned on and controlled by the child) at pre-determined times programmed into the clock 100. For example, the child may be able to use the music player's controls 304 only when an indicator light 306 is on (e.g., at times programmed by the parent). In other implementations, the music player may turn on at a pre-set time, such as when the music serves as an alarm when the clock 100 is used as an alarm clock. In other implementations, the timepiece 100 can be included with, or serve as, a wall clock. In other implementations, the timepiece 100 may be mounted on a crib or toddler bed using a strap or other attaching method.

Controls 304 may include buttons and/or other controls that are generally available as audio/visual functions, such as play, record, rewind, stop, fast-forward, erase, skip, pause, volume-up, volume-down, mute, scan, seek, zoom, pan, etc. Other controls may allow the child to view screens or other visual displays, such as a DVD player.

The cabinet 302 may also include speakers 308a and 308b that are integrated with the music player. Other entertainment features (not shown) may be included, such as one or more speakers, and one or more openings or ports for digital video discs (DVDs), compact discs (CDs), MP3 access, or other multimedia formats. In some implementations, these entertainment features (such as an audio player) may be built into the timepiece, while in other implementations they maybe add-on modules, or attach to the timepiece via a port or other connection. In some implementations, such features may be available for use by the child at any time. In other implementations, the features may be available only at pre-programmed times. In further implementations, the child's parent can optionally control the availability of such features, such as with a switch or remote control.

In some implementations, the cabinet 302 may house various lights, such as a nightlight 310 and/or a reading light 312. The nightlight 310 may be integrated into the programmability of the clock 100. For example, the nightlight 310 may switch on automatically at a pre-programmed time (e.g., at the same time that the star images 106a and 106b are displayed). Similarly, the reading light 312 control may be programmed (e.g., via the clock 100) to be operable at a pre-determined time, such as for an hour around bedtime. Switches 314 may allow the child to operate the nightlight 310 and the reading light 312.

In other implementations, the volume controls of the clock 100 may be integrated with the programmability of the clock 100. For example, during quiet times or sleeping hours, the volume may automatically be muted or reduced. For example, depending on the time of day, the maximum volume settable by the child may be reduced. These times may or may not correspond to the times that the nightlight 310 and reading light 312 are operable. For example, depending on the time of day, the nightlight 310 and the reading light 312 may be unavailable to the child, or their maximum light output may be limited. In some implementations, programmable settings for lights and volume controls may be integrated with a light sensor, for example, capable of determining dusk and dawn. For example, the clock 100 may be programmable to enable a nightlight at dusk, have a reading light available to the child for an hour after dusk, and have a maximum volume control that is reduced soon after dusk.

The clock 100 may also include an analog time display 316. For example, such a display 316 may be used instead of (or in combination with) the digital time display 202 (refer to FIG. 2). For example, an adult may program the clock 100 to display both the digital time display 202 and the analog time display 316 when the child is ready to advance past the image-based displays. In different implementations of an analog display 316, numbers representing hours 1-12 may (or may not) be present at the hour locations of the clock face.

Some implementations of the clock 100 may include one or more remote controls. For example, a child's remote control may allow the child to control selected features of the clock 100, such as music controls and reading lights. A parent's remote control may provide access to the same clock 100 features, as well as access to programming features (e.g., setting waking time, quiet play time, etc.). Moreover, a parent's remote control may allow the parent to program the availability of features on the child's remote control (e.g., the child's ability to change music volume).

In addition to playing music, the clock 100 may be able to play pre-recorded messages. For example, a child's mother may record a soothing morning announcement such as “Good morning, Sweetie.” that plays each morning at a time pre-programmed by the child's mother. Similar messages can be recorded for play at the beginning of a time period (e.g., “Time for quiet time, Sweetie”) or when it's time for a meal (e.g., “Almost time for dinner, Sweetie.”), to name a few examples. Other messages can be recorded for play at the end of a time period, such as “Quiet time is over; you can come down when you're ready.” Yet other messages may be recorded that play at random waking times, such as “Hope you're having fun now.” In some implementations, a queued-up or real-time message may be sent on demand by a parent, such as by the parent using one or more controls on a remote control (e.g., from another room in the home).

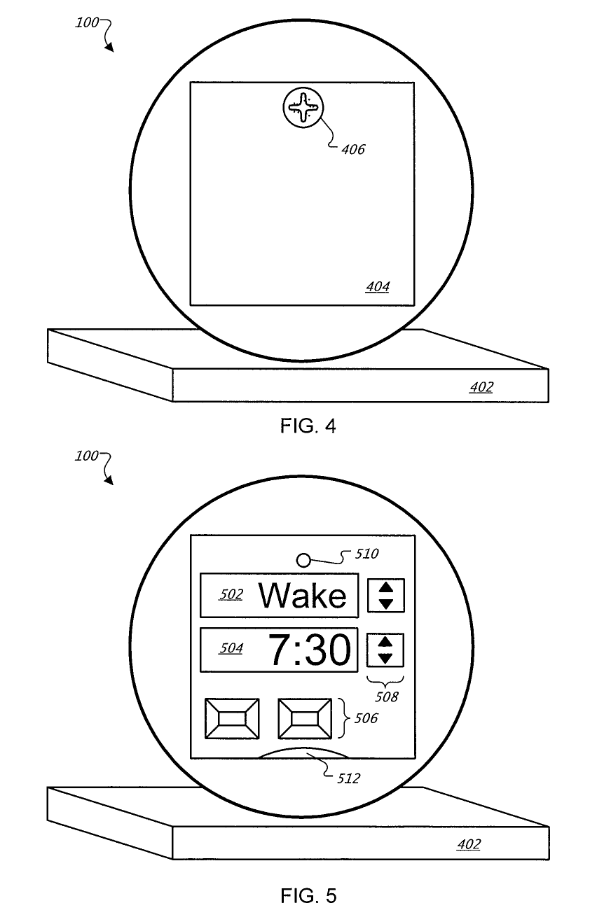

FIG. 4 shows an example back side of the clock 100. As depicted, the clock 100 is in a table-top configuration, mounted on a base 402. The back of the clock 100 includes a cover 404 that can be used to hide the adult-programmable controls of the clock 100. For example, the cover 404 can prevent the child from changing the settings on the clock 100, such as waking time, sleep time, etc. The cover may be detachable, for example, by removing a screw 406. Other configurations of fasteners may be used such that removal of a screw 406 is not necessary in order to access the controls.

FIG. 5 shows example controls that can be used for programming the table-top clock 100. Such programming features may provide the ability to introduce complexity as the child gets older. For example, while a younger child may initially rely entirely on color or rely on images, lights and colors to tell time, an older child may be able to understand (and benefit from) the added complexity of a timepiece that displays a digital and/or analog clock.

The same or different controls can be used to program other configurations of the clock 100, such as those depicted in FIGS. 1-4. Specifically, such controls can be used to set the times associated with the features of the clock 100. For example, the controls can be used to set the start and end times for images 104-112 depicted in FIG. 1A. In another example, the controls can be used to manage the availability of the digital time display 202 in FIG. 2 and the analog time display 316 of FIG. 3. In a further example, the controls can be used to enable and disable features of the stacked configuration of the clock 100 depicted in FIG. 3, such as the music player's controls 304 and the reading light 312.

The controls can include a feature name display 502. The feature name display 502 can identify the control currently being set. For example, when an adult is programming the start time for “waking time,” the feature name 502 may display “Wake.” Simultaneously, a time display 504 may display the current setting of the start time for the corresponding feature name 502. For example, as depicted in FIG. 5, “7:30” may be the currently-programmed start time for the “waking” time. In particular, the 7:30 start time may correspond to the “waking” time represented by the sun image 104 in FIG. 1A.

In some implementations, other time-related displays (e.g., durations) not depicted in FIG. 5 may exist. A time duration may be used in combination with a start time provided in the time display 504. A time duration may be measured by elapsed time rather than specific clock times. For example, while setting the start time for the reading light 312 depicted in FIG. 3, a time duration of an hour may also be specified.

Controls for programming the clock 100 may also include buttons 506 and 508. For example, buttons 506 may allow the person who is programming the clock 100 to advance forward and backward though options, such as to advance to another setting for a feature of the clock 100. Buttons 508 may allow the programmer to scroll through values in displays 502 and 504, such as to increase or decrease the time setting on a particular feature (e.g., the “Wake” time of 7:30).

Other controls not shows in FIG. 5 may be used to program the colors of various images displayable on the clock 100. For example, while a parent is changing the start time for quiet play time, the parent may also change the color, and/or associated image (e.g., train image 108 or book image 110).

Other controls not shown may allow a child's parent or guardian to record messages that can play at designated times. For example, a child's mother may record a message that plays each morning when the “waking” time begins. Other controls may control the volume of the message.

When the protective cover 404 of the clock 100 is removed, components that help to hold the cover 404 in place may be exposed. These can include, for example, a screw hole 510 (e.g., for accepting screw 406 in FIG. 4) and a tab opening 512 (e.g., for accepting the tab end of the cover 404 if one is used).

Various others ways may exist and be used by a parent or guardian to provide programming information to the clock 100. In some implementations, the clock 100 may have one or more Universal Serial Bus (USB) ports for receiving downloaded programming instructions. In other implementations, the clock 100 may use other types of interfaces, such as a wireless interface or an infra-red interface. In some implementations, a parent may be able to program the clock 100 using a computer, cell phone, or personal digital assistant (PDA). Other programming methods may use voice activation or biometric access of some kind.

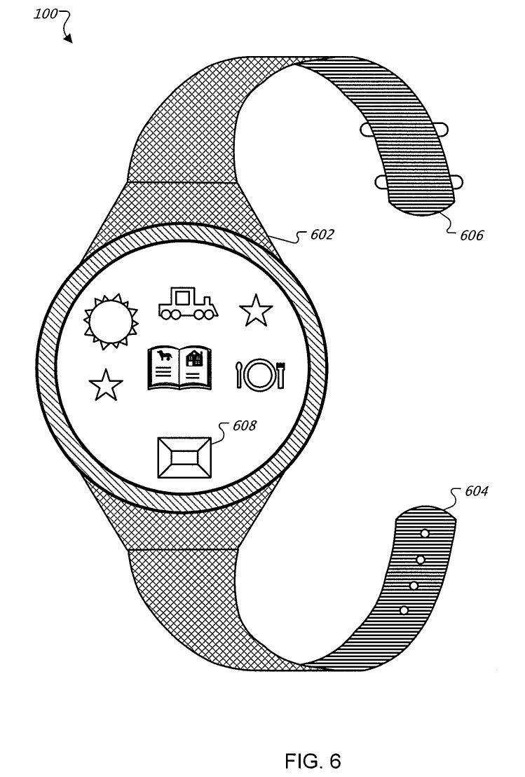

FIG. 6 shows an example watch configuration 602 for housing the timepiece 100. For example, the watch 602 may include some or all of the clock 100 features described above. The watch 602 may further be wearable by a child, such as by connecting strap end 604 into clasp end 606 (e.g., as in an ordinary strap-type watch band). In some implementations, other fastening methods (e.g., hook-and-loop fasteners, elastic, etc.) may also be used. In other implementations, the timepiece 100 may be housed in a pocket watch or by other means, such as in a piece of jewelry (e.g., a pendant, charm, etc.). The watch 602 may include one or more buttons 608 that the child may use, for example, to control features on the watch 602.

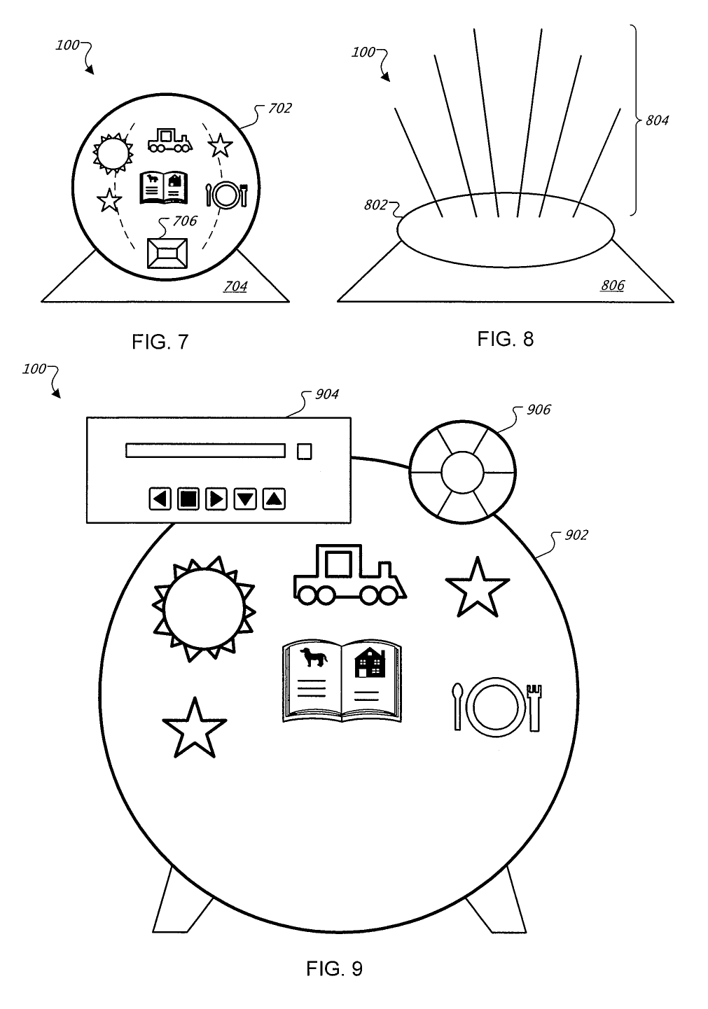

FIG. 7 shows an example globe configuration 702 for housing the timepiece 100. The globe 702 can be, for example, a sphere made or glass, plastic or other transparent, semi-transparent, or translucent material. The globe 702 can contain a timepiece 100 having some or all of the features described above. Abase 704 can support the globe 702 and may provide access (e.g., via the base's underside) to programming controls that can be used to program the timepiece 100. One or more buttons 706 may be included on the globe 702. The buttons 706 may, for example, allow the child to control features of the globe 702, such as a light to make the globe 702 or base 704 glow in the dark. While the globe 702 depicted in FIG. 7 is a sphere, other shapes can be used to house the timepiece 100. The color and/or images described earlier may be displayed on the inner surface of the globe for viewing by a child or other individual.

FIG. 8 shows an example projector configuration 802 for housing the timepiece 100. The projector 802 may, for example, project a likeness of the timepiece 100 on a wall or ceiling. The projector may also simply project a color corresponding to the program controls. The projection may be projected using various methods such as lights, lasers or holograms whether the displayed projection is color, such likeness or other. As shown, beams 804 depict the upward direction (e.g., toward a ceiling or upper surface) of the projection 802, but beams 804 can also emanate in a sideways direction. In some implementations, beam direction of the projector 802 may be adjustable, such as by the child's parent. In other implementations, the projector 802 may be programmable so that the beam direction moves over time, such as to mimic the sunrise and sunset cycle of a typical day. The projector 802 can be housed in a base 806. In some implementations, the base 806 may be operable to glow in the dark. In other implementations, the base may operate to display colors and/or images corresponding to the projections. As one illustrative example, the projection may be an image of a plate and silverware with an orange color, and the base may glow orange at the same time.

FIG. 9 shows an example CD player and light configuration 902 for housing the timepiece 100. For example, a CD player 904 and a light 906 can occupy the spaces that alarm bells on an alarm clock may normally occupy. Specifically, referring to FIG. 1A, the CD player 904 and the light 906 can replace the bells at the top of the alarm clock 100.

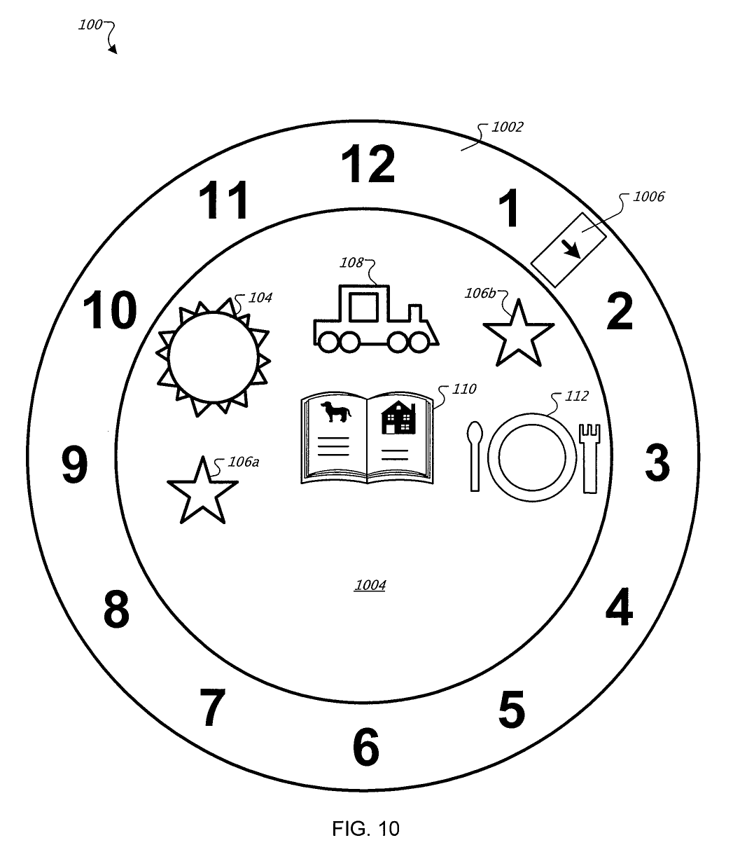

FIG. 10 shows an example timepiece 100 that includes an outer hours region 1002. As depicted, the hours region 1002 includes the hour numbers one to twelve. The outer hours region 1002 may be used in combination with other elements on the timepiece 100, such as images 104-112. In particular, changes to the hour numbers may coincide with changes to images 104-112, such as resulting from programming the timepiece 100.

In some implementations, clock face 1004 may change colors over time, while the hour numbers remain a constant color (e.g., red, black, etc.). For example, the clock face 1004 may glow blue at night and yellow during the day. In another example, the clock face 1004 may display a special progression of colors for particular events, such as slowly changing from yellow to blue to represent a sunset.

In other implementations, clock face 1004 may remain the same color, while the hour numbers in the hours region 1002 change. To indicate the slow passage of an hour, the color change of the hour numbers may be gradual. For example, an hour numeral changing colors (e.g., from yellow to red) may undergo the change over several minutes, displaying intermediate color blends (e.g., orange). In some implementations, hour numerals may blink momentarily, and/or an audible sound may occur, such as when the time changes to a new hour.

In some implementations, a colored marker 1006 may be displayed within the hours region 1002. The marker 1006 may be a line, box or other shape that rotates through the hours region 1002, passing by an hour number each hour. The location of the marker 1006 can indicate the relative time. For example, as depicted, the marker 1006 is between the hours of one and two, indicating an approximate time of 1:30. The child may interpret the depicted location of marker 1006 as indicating a time that is between 1:00 and 2:00.

In some implementations, hours can be represented in other ways, such as by using Roman numerals I through XII in place of the hour numbers in the hours region 1002. In other implementations, hours numbers can use military time (e.g., hours 1 to 24).

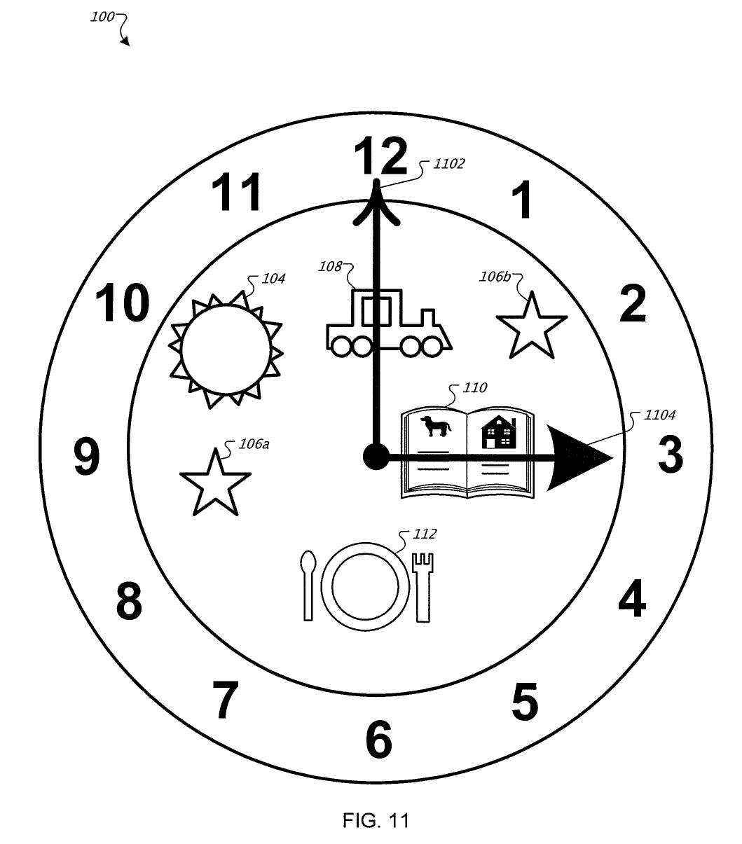

FIG. 11 shows an example timepiece 100 that includes an hour hand 1102 and a minute hand 1104. Hands 1102 and 1104 may be any color or shape, such as to allow a toddler to differentiate between their meaning (e.g., hours and minutes). For example, as depicted, the arrowhead of hour hand 1104 is depicted as larger than the arrowhead of minute hand 1102.

In some implementations, the display of hands 1102 and 1104 may be programmable. For instance, a toddler's parent may program the timepiece 100 to display the hands 1102 and 1104 when the toddler is thought to be able to understand the meaning of the hands 1102 and 1104. When the hands 1102 and 1104 are not displayed, the child may rely on images 104-112 to tell time.

In some implementations, the hands 1102 and 1104 may be displayed while the images 104-112 are hidden. For example, the child's parent may use programming controls to hide the images 104-112, such as when the child is initially learning to tell time using analog displays. In other implementations, the hands 1102 and 1104 may be displayed together with a color in display area, while the images are hidden or not displayed.

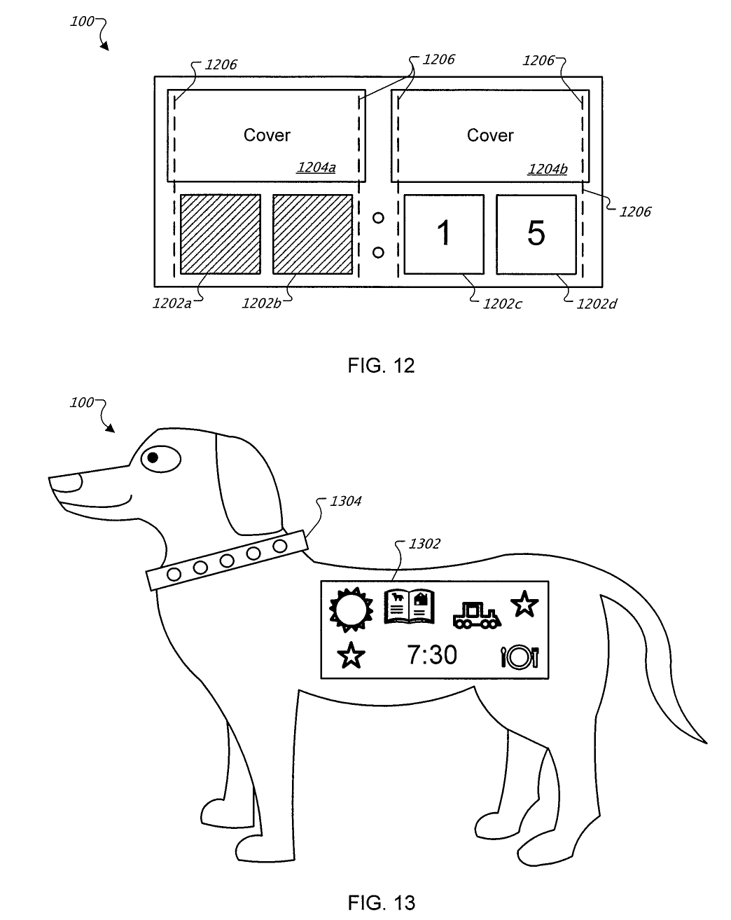

FIG. 12 shows an example of a digital clock implementation of the timepiece 100. The time on the digital clock can be represented using digits 1202a-1202d. Specifically, digits 1202a and 1202b can represent the hour portion of the current time, and digits 1202c and 1202d can represent the minute portion. Any of the digits 1202a-1202d can be actual digits, or they can be colored cells or other shapes, images, lights, etc. that represent particular times of the day. Covers 1204a and 1204b can be used to hide portions of the digits 1202a-1202d. For example, a parent may slide cover 1204b down over the top of digits 1202c and 1202d for a toddler who may not be ready to comprehend minutes. In one implementation, covers 1204a and 1204b can slide along channels 1206 that are operable to permit free up-and-down movement of the covers 1204a and 1204b. In some implementations, covers 1204a and 1204b may include an enabling button (not shown) that prevents a child from operating the covers 1204a and 1204b while permitting adults to enable and slide the covers.

FIG. 13 shows an example of the timepiece 100 built into an object. As depicted, the timepiece 100 is embedded in the body of a dog, but any shape or object can be used. The clock area 1302 can include elements of timepieces 100 described above, such as images, colors, digital displays, etc. In some implementations, adult programming controls and/or child-operable controls may be included in a collar 1304. Such controls may be in the form of buttons or other controls on the collar 1304. The timepiece may be built into a variety of objects, such as toys, dolls, cars, toy animals, etc.

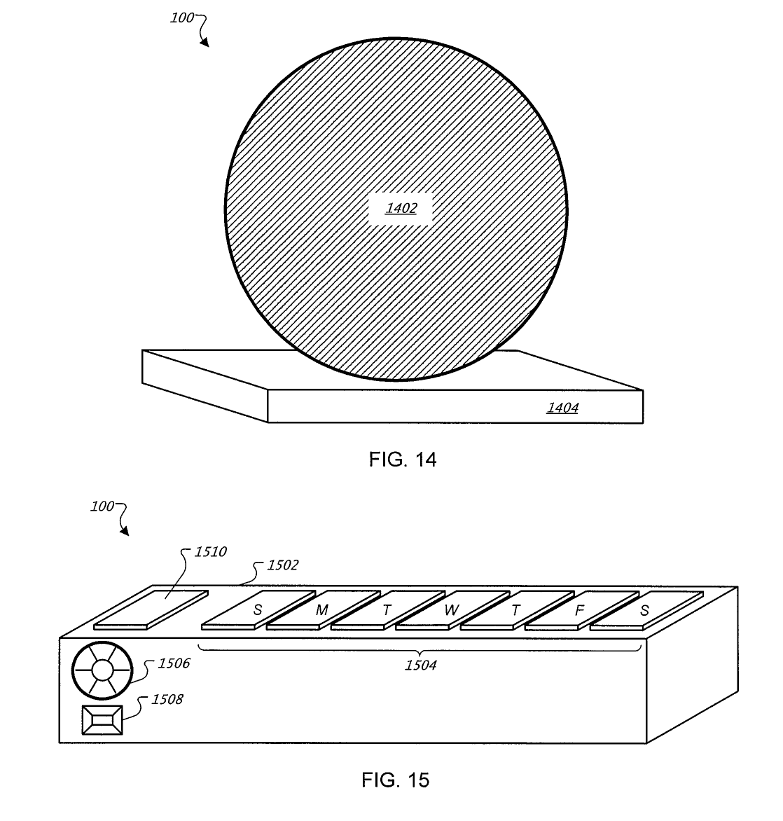

FIG. 14 shows an example orb clock 1402 implementation of the timepiece 100 that uses color to indicate the current time. The orb clock 1402 can be similar to the clock of FIG. 1b, and can change color to indicate different times of the day. For example, daytime or “waking” hours can be represented when the clock appears or glows yellow. The orb clock 1402 can be mounted on a base 1404. The underside of the base 1404 can include an access panel or other area that houses programming controls for the orb clock 1402. For example, by accessing the controls, an adult may program the particular times that the orb clock changes color to indicate time.

FIG. 15 shows an example of the timepiece 100 built into a pill box 1502. In other implementations, the timepiece 100 may be embedded in or otherwise integrated with other types of containers, such as containers containing solids, liquids and/or gasses, etc. As depicted, the time-keeping portion of the timepiece 100 is embedded within the pill box 1502. As such, the time-keeping portion partially controls the functionality of the pill box 1502. Specifically, the time-keeping portion can control the availability (e.g., ability to be opened) of compartments 1504 for dispensing pills, such as medications for seniors. In some implementations, individual compartments 1504 may not be opened (e.g., by the pill-taking patient) until the time-keeping portion of the pill box 1502 determines that it is time to “take medicine now.”

The pill box 1502 includes several pill compartments 1504, a color circle 1506, a button 1508, and a controls cover 1510. Using programming controls (e.g., as described above with respect to FIG. 5) accessible via controls cover 1510, the pill box 1502 may be programmed to dispense medications (e.g., pills) at certain times. For example, in one scenario, the pill box 1502 may be filled with pills by a patient and programmed to dispense the pills at pre-determined times. When the time-keeping portion within the pill box 1502 determines that it is time for dispensing medication (e.g., pills), the color circle 1506 may change color (or otherwise provide a visual cue), and an alarm may sound. In some implementations, the alarm may continue to sound until the button 1508 is pressed, at which time the color circle 1506 may revert to its “do not take medicine now” color. In other implementations, the specific compartment of the pillbox may light up with the same color as the color circle, or the compartment may light up instead of a color circle.

In another scenario, the pill box 1502 may be automatically filled and programmed at a pharmacy. For example, the pill box 1502 may be filled with a supply (e.g., a month's supply) of medications for a patient, such as a senior citizen. The pill box may have as few as one of the compartments 1504 for dispensing pills. As such, internal mechanisms within the pill box 1502 may exist that are operable to automatically fill a single one of the compartments 1504 from a larger supply if pills contained within the pill box 1502. When the senior citizen takes the pill box 1502 home, automatic dispensing of the medication can commence. For example, if the pills taken twice daily, the pill box 1502 may sound an alarm in the morning and evening (e.g., at times convenient for the patient and programmed at the pharmacist). When the senior removes the pill(s) from the pill box 1502 (e.g., via a single one of the compartments 1504) at a pre-programmed time, the pill box 1502 can automatically prepare for the next dispensing time. In particular, the pill box 1502 may move the next dosage of pill(s) into the single one of the compartments 1504.

In some implementations, the pill box 1502, and as such the timepiece 100, may automatically send a warning to a remote location if a dosage is not taken as planned. For example, if the patient fails to remove the pill(s) at a predetermined time, the timepiece 100 may send an alert to the pharmacy and/or a family member or guardian. The alert can include one or more of a phone call, page, text message, email, etc. In this way, the timepiece 100 can help in monitoring a patient, such as a senior citizen living alone, who may be at risk for skipping medications.

The compartments 1504 may correspond to daily medications. The lids of the compartments 1504 can be labeled with initials “S” through “S” that correspond to the days Sunday through Saturday. In some implementations, the pill box 1502 may have twice as many or more compartments, such as for twice daily or more frequent medications.

The color circle 1506 may include lights, light-emitting diodes (LEDs) or some other mechanisms that can provide a visual change of color. The change of color may also be accompanied by flashing or other visual effects. The compartments 1504 may include lights, light-emitting diodes (LEDs) or some other mechanisms that can provide a visual change of color. The change of color may also be accompanied by flashing or other visual effects

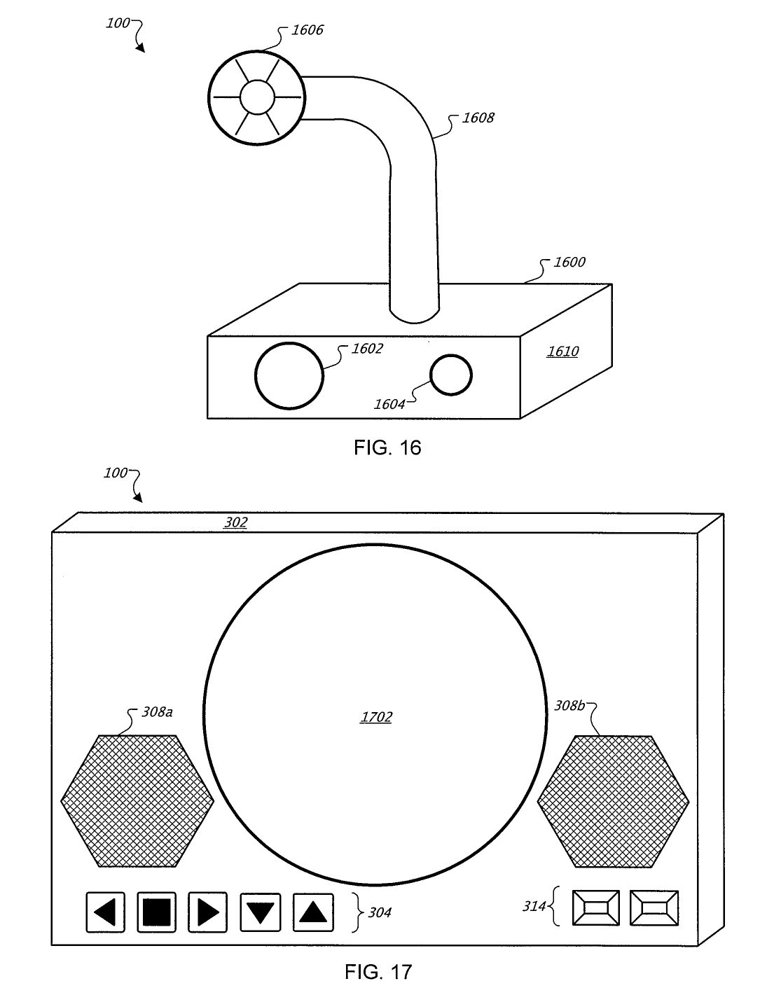

FIG. 16 shows an example of the timepiece 100 built into an independent desk light 1600. As depicted, the time-keeping portion of the timepiece 100 is embedded within the desk light 1600. As such, the time-keeping portion partially controls the functionality of the desk light 1600. Specifically, the time-keeping portion can control the availability (e.g., ability to be operated) of the desk light 1600, such as when it can be turned on by a child. For example, the child's parent may use programming controls (e.g., as described above with respect to FIG. 5) to enable the desk light at certain times. The programming controls may be available via the base of the desk light 1600, for example.

The independent desk light 1600 includes a color circle 1602 and a button 1604. The color circle 1602 changes color according to time. The button 1604 is an on/dim/off button that enables the light to be turned on when the appropriate color is shown in the circle. For example, the color circle 1602 may be green (or some other color) when the desk light 1600 is enabled (e.g., controllable by the child). While the desk light 1600 is enabled, the child can operate the button 1604 to turn on the light, dim the light, or turn off the light. To indicate that the desk light 1600 is disabled, the color circle 1602 may be red (or some color other than the enabled color).

In the implementation depicted, the light emits from a light element 1606 at the end of a bendable arm 1608 attached at a base 1610. In other implementations, the light may be separate from the base 1610, such as mounted on the wall above the child's bed.

FIG. 17 shows an example of the timepiece 100 built into an independent music player. For example, the music player may have the same or different capabilities as the music player shown in FIG. 3. As depicted in FIG. 17, the time-keeping portion of the timepiece 100 is embedded within the music player. As such, the time-keeping portion partially controls the functionality of the music player, such as when it can be operated by a child. For example, the child's parent may use programming controls (e.g., as described above with respect to FIG. 5) to enable the desk light at certain times. In particular, a color region 1702 may show a specific color (e.g., green) when the music player is enabled.

In some implementations, the timepiece 100 can be used by individuals who are not children but may have learning disabilities that prevent them from recognizing conventional clocks (e.g., analog, digital, etc.).

In some implementations, additional time-related information can be provided by the timepiece 100. For example, images and/or displays related to days, weeks, months and years can be incorporated into various configurations of the clock 100. Specifically, a calendar display can provide information about the name of the day of the week and the date (e.g., month, day and year). Such information may be, for example, part of a calendar display. Initially, the information may be presented in a simplified way for younger children, and become more complex as the child progresses in the understanding of time. For example, a parent may program the clock 100 to display day and month information once a child is old enough to understand.

In some implementations, one or more images can be added to the face of the clock 100 that provide a symbolic countdown of days remaining until an upcoming event. For example, three small images of clocks may be displayed on the face of the clock to signify three days until a special birthday party or until a parent is expected back in town after a business trip. Such a display can be updated automatically each day, such as during the night, to remove one of the remaining symbols.

In some implementations, some programming controls may be available to the child. In this way, the child may be able to program future events or activities, or to set up reminders. Some of this type of programming by the child may rely on help from a parent or guardian, such as to select the precise time of the event or activity.

In some implementations, the timepiece 100 can be included in (or be implemented as) a decorating piece, such as a wall-mounted, tabletop or other decorative color wheel that changes color. Such a timepiece 100 may be programmed (e.g., using programming controls such as those described with respect to FIG. 5) to automatically change colors at pre-determined times. The timepiece 100 may also include an analog or digital clock.

A number of embodiments of the invention have been described. Accordingly, other embodiments are within the scope of the following claims.

What is claimed is:

1. A timepiece apparatus, comprising:
a display area that is able to present different colors;
a timing mechanism that is able to track the passage of time;
a display mechanism that is able to change the color of the display area, wherein the color corresponds to a time period; and
an interface for associating the color displayed with the time period, wherein the association is customizable by a user.

2. The timepiece apparatus of claim 1, wherein the interface for associating the color displayed with the time period may utilize elapsed time measurement for changing the color displayed.

3. The timepiece apparatus of claim 1, wherein the interface for associating the color displayed with the time period may utilize actual clock time measurement for changing the color displayed.

4. The timepiece apparatus of claim 1, wherein the display area is able to present one or more images.

5. The timepiece apparatus of claim 1, wherein the display area comprises a device for projecting the color displayed against another surface external to the device.

6. The timepiece apparatus of claim 1, further comprising one or more speakers and a device for playing audio.

7. The timepiece apparatus of claim 7, wherein the device for playing audio comprises a media player, such as an mp3 player, CD player, or cassette player.

8. The timepiece apparatus of claim 7, wherein the device for playing audio comprises an interface able to connect to or communicate with an external audio device, such as an mp3 player or other device.

9. The timepiece apparatus of claim 7, wherein the device for playing audio is connected with the timing mechanism, such that audio may only be played at certain times which correspond with specified color displays.

10. The timepiece apparatus of claim 1, further comprising a reading light, wherein the reading light is connected with the timing mechanism, such that the reading light may only be operated at certain times which correspond with specified color displays.

11. The timepiece apparatus of claim 1, further comprising a remote control, wherein the remote control may be used to access programming features of the timepiece apparatus.

12. The timepiece apparatus of claim 1, further comprising a night light.

13. The timepiece apparatus of claim 1, further comprising a digital display.

14. The timepiece apparatus of claim 1, further comprising an interface for communicating, such that the device settings may be obtained from an external device or source.

15. The timepiece apparatus of claim 1, wherein the timepiece apparatus is built into a doll, animal, car, or other toy.

16. A system for telling or teaching time, comprising:
means for measuring the passage of time;
means for setting a time period;
means for displaying a color, wherein the color displayed corresponds to the time period; and
means for associating the displayed color with the time period.

17. The system of claim 16, wherein the means for displaying a color comprises an area for projecting the color displayed on the device.

18. A container apparatus, comprising:
one or more compartments able to hold small objects;
a display area that is able to present different colors;
a timing mechanism that is able to track the passage of time;
a display mechanism that is able to change the color of the display area, wherein the color corresponds to a time period; and
an interface for associating the color displayed with the time period, wherein the association is customizable by a user.

19. The container apparatus of claim 18, further comprising an audio alert system.

20. The container apparatus of claim 18, further comprising a visual alert system.
